(19) United States
(12) Patent Application Publication
(10) Pub. No.: US 2009/0174848 A1
(43) Pub. Date: Jul. 9, 2009

(54) LIQUID CRYSTAL DISPLAY MODULE FOR AN INFORMATION PROVIDING MACHINE

(76) Inventors: Chiung-Chi Lin, Taipei City (TW); Ching-Yi Lin, Taipei City (TW)

Correspondence Address: POTTER ANDERSON & CORROON LLP;ATTN: JANET E. REED, PH.D., P.O. BOX 951, WILMINGTON, DE, 19899-0951, US

(21) Appl. No.: 12/338,616

(22) Filed: Dec. 18, 2008

(30) Foreign Application Priority Data
Jan. 9, 2008 (TW) 097100813

(51) Int. Cl. G02F 1/1335

(52) U.S. Cl. 349/96; 349/106

(57) ABSTRACT

A liquid crystal display module includes a backlight unit having a light exiting surface, a first polarizing layer disposed on the light exiting surface of the backlight unit, a liquid crystal cell disposed on one side of the first polarizing layer opposite to the backlight unit, a protective glass panel disposed on one side of the liquid crystal cell opposite to the first polarizing layer and cooperating with the liquid crystal cell to define a heat-dissipating space therebetween, and a second polarizing layer disposed on one side of the protective glass panel opposite to the liquid crystal cell.

### CROSS-REFERENCE TO RELATED APPLICATION

This application claims priority of Taiwanese Application No. 097100813, filed on Jan. 9, 2008.

### BACKGROUND OF THE INVENTION

1. Field of the Invention

The invention relates to a liquid crystal display module, more particularly to a liquid crystal display module for an information providing machine.

2. Description of the Related Art

An information providing machine 10, also known as Kiosk, is a computer terminal for access of electronic information. The information providing machine 10, as shown in FIG. 2, is also known as a self-service machine that provides interactive information to users in an interactive manner. For instance, the Kiosks can be found in convenience stores, or implemented as Automated Teller Machines (ATMs) or as public computer terminals.

The information providing machine 10 includes a liquid crystal display module 90, which serves as an interface for users to access the information. As shown in FIGS. 1 and 2, the liquid crystal display module 90 is mounted in a housing 3 and has a backlight module 91 for emitting light beams outwardly of the liquid crystal display module 90 (shown by dotted lines in FIG. 1), a first polarizing layer 92, a liquid crystal cell 93, a second polarizing layer 94, and a protective glass panel 95 cooperating with the second polarizing layer 94 to define a heat-dissipating space 96 therebetween.

However, one problem associated with the liquid crystal display module 90 is that after the light beams are filtered by the second polarizing layer 94, the light beams are required to pass through the heat-dissipating space 96 and the glass panel 95 before exiting the light crystal display module 90. When the light beams pass through the heat-dissipating space 96, the light beams are undesirably refracted due to hot air accumulated in the heat-dissipating space 96, which results in distorted images. Besides, the reflective glare of the glass panel 95 can render viewing of information difficult for some users.

### SUMMARY OF THE INVENTION

Therefore, an object of the present invention is to provide a liquid crystal display module that can overcome the above drawbacks of the prior art.

According to the present invention, a liquid crystal display module includes a backlight unit having a light exiting surface, a first polarizing layer disposed on the light exiting surface of the back light unit, a liquid crystal cell disposed on one side of the first polarizing layer opposite to the backlight unit, a protective glass panel disposed on one side of the liquid crystal cell opposite to the first polarizing layer and cooperating with the liquid crystal cell to define a heat-dissipating space therebetween, and a second polarizing layer disposed on one side of the protective glass panel opposite to the liquid crystal cell.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic side view of a conventional liquid crystal display module;

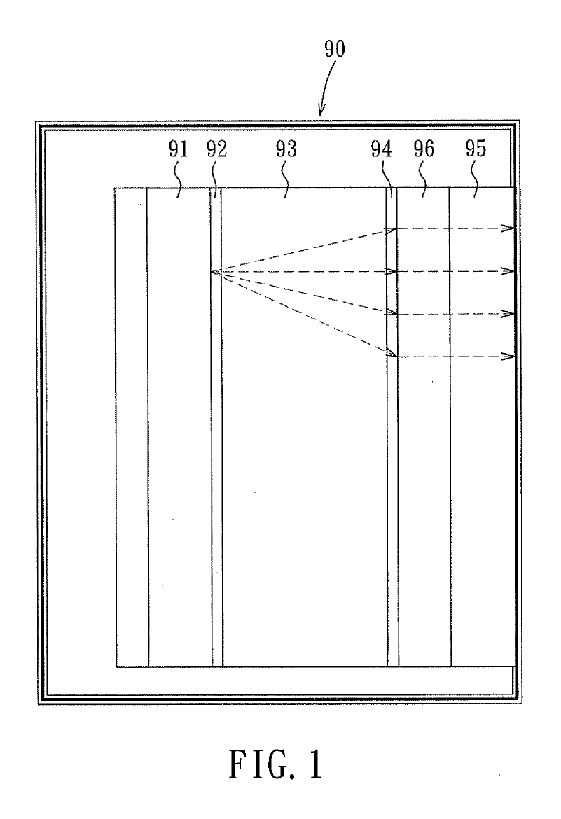

FIG. 2 is a schematic view of the conventional liquid crystal display module installed in an information providing machine;

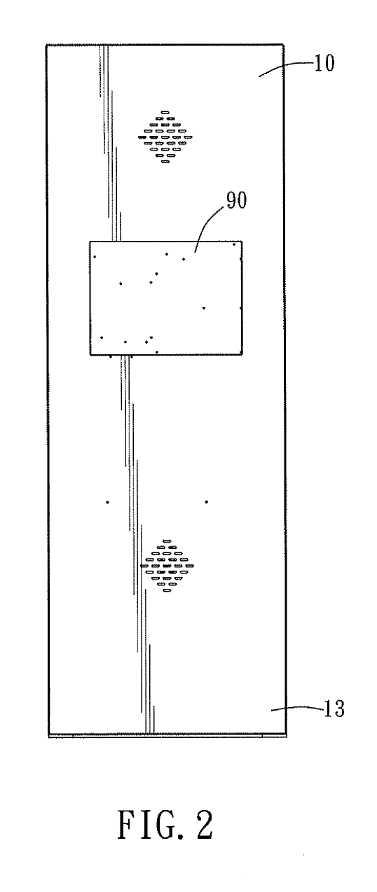

FIG. 3 is a schematic side view of the preferred embodiment of a liquid crystal display module according to the present invention; and

FIG. 4 is a schematic view of the preferred embodiment of the liquid crystal display module installed in an information providing machine.

### DETAILED DESCRIPTION OF THE PREFERRED EMBODIMENT

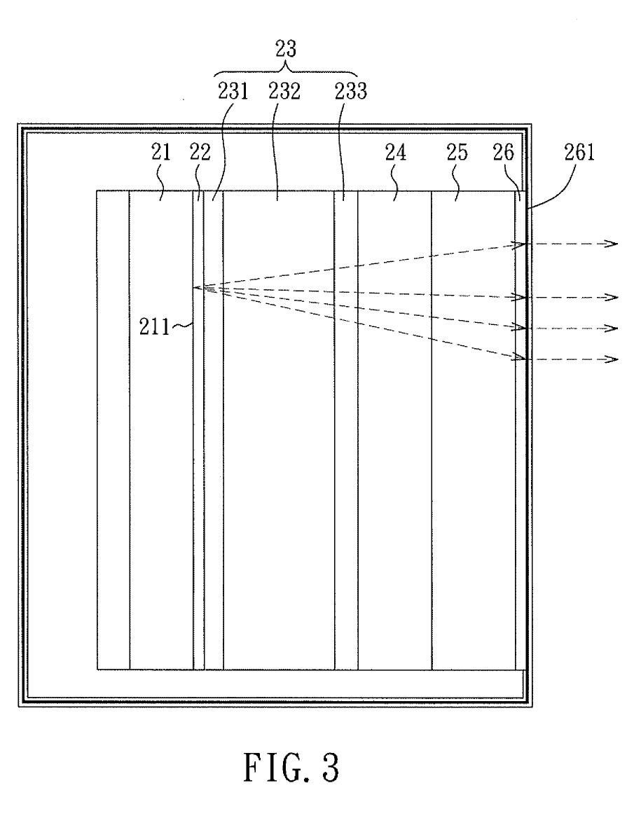

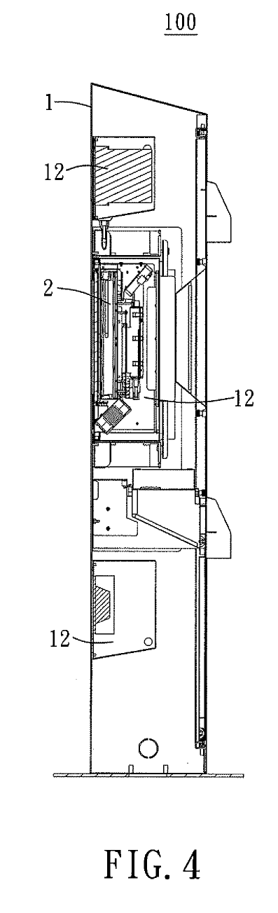

Referring to FIGS. 3 to 4, the preferred embodiment of a liquid crystal display module 2 according to the present invention is adapted for use on an information providing machine 100. The information providing machine 100 includes a housing 1, an electronic control unit 12 disposed in the housing 1, and a liquid crystal display module 2 coupled electrically to the electronic control unit 12.

The liquid crystal display module 2 includes a backlight unit 21 having a light exiting surface 211 and operable to emit light beams, a first polarizing layer 22 disposed on the light exiting surface 211 of the backlight unit 21, a liquid crystal cell 23 disposed on one side of the first polarizing layer 22 opposite to the backlight unit 21, a protective glass panel 25 disposed on one side of the liquid crystal cell 23 opposite to the first polarizing layer 22 and cooperating with the liquid crystal cell 23 to define a heat-dissipating space 24 therebetween, and a second polarizing layer 26 disposed on one side of the protective glass panel 25 opposite to the liquid crystal cell 23. In this embodiment, the second polarizing layer 26 has at least one of an anti-glare treated surface and an anti-reflection treated surface for alleviating the reflective effect of sunlight. Also, the second polarizing layer 26 can include a dye type polarizing film thereon to prevent damage due to high ambient temperature. The liquid crystal cell 23 includes an active matrix glass substrate 231 proximate to the first polarizing layer 22, a color filter 233 proximate to the space 24, and a liquid crystal layer 232 disposed between the active matrix glass substrate 231 and the color filter 233. The liquid crystal cell 23 is a semi-transparent semi-reflective liquid crystal cell in this embodiment. Preferably, a distance between the liquid crystal cell 23 and the protective glass panel 25 ranges from 2 mm to 12 mm. An imaging plane 261 of the liquid crystal display module 2 is disposed at the second polarizing layer 26.

In operation, the backlight unit 21 emits the light beams, as shown by dotted lines in FIG. 3, in a direction towards the second polarizing layer 26 so that the light beams propagate through the first and second polarizing layers 22, 24, thereby displaying images on the imaging plane 261.

In view of the above, unlike the conventional liquid crystal display module 90, the second polarizing layer 94. However, in the present invention, since the second polarizing layer 26 is disposed as the outermost layer of the light crystal display module 2. Therefore, the light beams would undergo heat-dissipation in the heat-dissipation space 24 first before being filtered by the second polarizing layer 94, so that undesirable refraction can occur at an earlier stage before the light beams pass through the second polarizing layer 26, thereby improving the quality of displayed images while maintaining the heat dissipating efficiency of the module 2.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A liquid crystal display module comprising:
a backlight unit having a light exiting surface;
a first polarizing layer disposed on said light exiting surface of said backlight unit;
a liquid crystal cell disposed on one side of said first polarizing layer opposite to said backlight unit;
a protective glass panel disposed on one side of said liquid crystal cell opposite to said first polarizing layer and cooperating with said liquid crystal cell to define a heat-dissipating space therebetween; and
a second polarizing layer disposed on one side of said protective glass panel opposite to said liquid crystal cell.

2. The liquid crystal display module as claimed in claim 1, wherein an imaging plane of said liquid crystal display module is disposed at said second polarizing layer.

3. The liquid crystal display module as claimed in claim 1, wherein said second polarizing layer is a dye type polarizing film.

4. The liquid crystal display module as claimed in claim 1, wherein said second polarizing layer has an anti-glare treated surface.

5. The liquid crystal display module as claimed in claim 1, wherein said second polarizing layer has an anti-reflection treated surface.

6. The liquid crystal display module as claimed in claim 1, wherein a distance between said liquid crystal cell and said protective glass panel ranges from 2 mm to 12 mm.

7. The liquid crystal display module as claimed in claim 1, wherein said liquid crystal cell includes an active matrix glass substrate proximate to said first polarizing layer, a color filter proximate to said space, and a liquid crystal layer disposed between said active matrix glass substrate and said color filter.

8. The liquid crystal display module as claimed in claim 1, wherein said liquid crystal cell is a semi-transparent semi-reflective liquid crystal cell.

9. An information providing machine, comprising:
a housing;
an electronic control unit disposed in said housing; and
a liquid crystal display module coupled electrically to said electronic control unit, said liquid crystal display module including
a backlight unit having a light exiting surface,
a first polarizing layer disposed on said light exiting surface of said backlight unit,
a liquid crystal cell disposed on one side of said first polarizing layer opposite to said backlight unit,
a protective glass panel disposed on one side of said liquid crystal cell opposite to said first polarizing layer and cooperating with said liquid crystal cell to define a heat-dissipating space therebetween, and
a second polarizing layer disposed on one side of said protective glass panel opposite to said liquid crystal cell.

10. The information providing machine as claimed in claim 9, wherein an imaging plane of said liquid crystal display module is disposed at said second polarizing layer.

11. The information providing machine as claimed in claim 9, wherein said second polarizing layer is a dye type polarizing film.

12. The information providing machine as claimed in claim 9, wherein said second polarizing layer has an anti-glare treated surface.

13. The information providing machine as claimed in claim 9, wherein said second polarizing layer has an anti-reflection treated surface.

14. The information providing machine as claimed in claim 9, wherein a distance between said liquid crystal cell and said protective glass panel ranges from 2 mm to 12 mm.

15. The information providing machine as claimed in claim 9, wherein said liquid crystal cell includes an active matrix glass substrate proximate to said first polarizing layer, a color filter proximate to said space, and a liquid crystal layer disposed between said active matrix glass substrate and said color filter.

16. The information providing machine as claimed in claim 9, wherein said liquid crystal cell is a semi-transparent semi-reflective liquid crystal cell.
